(19) United States
(12) Patent Application Publication
(10) Pub. No.: US 2026/0273520 A1
(43) Pub. Date: Sep. 17, 2026

(54) DROPPER WITH BULB COMPRISING TERMOPLASTIC VULCANISATES

(71) Applicant: THE PROCTER & GAMBLE COMPANY, Cincinnati, OH (US)

(72) Inventors: Yang TIAN, Beijing (CN); Haiyan SUN, Beijing (CN)

(21) Appl. No.: 19/665,779

(22) Filed: May 1, 2026

Related U.S. Application Data
(63) Continuation of application No. PCT/CN2024/123665, filed on Oct. 9, 2024.

(30) Foreign Application Priority Data
Nov. 7, 2023 (WO) PCT/CN2023/130205

(51) Int. Cl. B01L 3/02

(52) U.S. Cl. CPC B01L 3/021; B01L 3/0282

(57) ABSTRACT

A dropper having a bulb, a pipette coupled to the bulb, and a cap coupled to the bulb. The bulb includes thermoplastic vulcanisates (TPV) having a shore A hardness of from about 40 to about 70. This provides a dropper with a bulb having a recyclable material and a good balance between dispensing force and anti-deformation.

### FIELD

This disclosure relates to a dropper, comprising: a bulb; a pipette coupled to the bulb; and a cap coupled to the bulb; wherein the bulb comprises a Thermoplastic Vulcanizate (TPV) having a Shore A hardness of from about 40 to about 70. The dropper provides a bulb comprising a recyclable material, and offers a good balance between dispensing force and anti-deformation. More generally, this disclosure pertains to droppers, and more specifically to a recyclable dropper.

### BACKGROUND

A dropper is a well-known device used to dispense liquids from a bottle. Typically, a dropper consists of a bulb; a pipette coupled to the bulb; and a cap coupled to the bulb. The cap holds the bulb and attaches to a bottle in a manner well known. The bottle usually contains liquid inside to be sold as a product with the dropper.

Droppers having one or all of its components made of materials that are not recyclable are well known. However, there is a need to improve recyclability of such dropper. One way to improve the recyclability is to change the material of the bulb to a recyclable material from, for example, commonly used rubber.

For example, APC's PCT patent application publication No. WO2022220871A1 is said to relate to a dropper that is recyclable, and discloses a dropper, comprising: a bulb composed entirely of one of: an ethylene propylene copolymer, a thermoplastic polyolefin, a thermoplastic elastomer, and a thermoplastic olefin elastomer; a pipette composed entirely of recyclable material that complies with recycle code “5” specifications, the pipette coupled to the bulb; and a cap composed entirely of recyclable material that complies with recycle code “5” specifications, the cap coupled to the bulb. Recyclable material that complies with recycle code “5” specifications is, for example, polypropylene.

However, the inventor found that, in such bulbs composed of recyclable materials, it is still difficult to balance between dispensing force and anti-deformation. Anti-deformation is a property expected for bulbs, so that the bulb is not deformed and/or the bulb does not have any unexpected wrinkle. Such deformation and/or wrinkle is mainly caused by “bending” of bulb which could happen, for example, during e-commerce transportation, when the product is not kept upwards and/or the product is accidentally dropped, especially for the product having a certain weight. Such deformation and/or wrinkle may not be caused by a conventional way to use the dropper, for example, by just sucking/dispensing. Anti-deformation properties may be improved, for example, by making the bulb wall thicker. However, such thicker bulb wall may increase the dispensing force, i.e., make the bulb stiffer for consumers to suck and/or dispense.

Thus, there is a need for providing a dropper comprising a bulb comprising a recyclable material, and has a good balance between dispensing force and anti-deformation.

### SUMMARY

A dropper, comprising: a bulb; a pipette coupled to the bulb; and a cap coupled to the bulb; wherein the bulb comprising Thermoplastic Vulcanisates (TPV) having a shore A hardness of from about 40 to about 70.

A dropper with a bulb comprising a recyclable material, and having a good balance between dispensing force and anti-deformation.

The inventor surprisingly found that by selecting TPV among a variety of materials, and by further selecting a certain hardness for such TPV, the bulb can achieve both anti-deformation and good dispensing force, as well as recyclability.

### BRIEF DESCRIPTION OF THE DRAWINGS

FIG. 1 is a front view of a dropper including a bulb, a cap and a pipette, with exemplified structures and shapes.

FIG. 2 is A-A cross-sectional view of the dropper shown in FIG. 1.

FIG. 3 is a front view of a two-piece dropper including a combined bulb and cap, and a pipette, with exemplified structures and shapes.

FIG. 4 is B-B cross-sectional view of the two-piece dropper shown in FIG. 3.

FIG. 5 is an illustration of Compression Test with steel customized jigs and fixtures.

### DETAILED DESCRIPTION

Reference within the specification to “embodiment(s)” or the like means that a particular material, feature, structure and/or characteristic described in connection with the embodiment is included in at least one embodiment, optionally a number of embodiments, but it does not mean that all embodiments incorporate the material, feature, structure, and/or characteristic described. Furthermore, materials, features, structures and/or characteristics may be combined in any suitable manner across different embodiments, and materials, features, structures and/or characteristics may be omitted or substituted from what is described. Thus, embodiments and aspects described herein may comprise or be combinable with elements or components of other embodiments and/or aspects despite not being expressly exemplified in combination, unless otherwise stated or an incompatibility is stated.

In all embodiments, all ingredient percentages are based on the weight of the cosmetic composition, unless specifically stated otherwise. All ratios are weight ratios, unless specifically stated otherwise. The number of significant digits conveys neither a limitation on the indicated amounts nor on the accuracy of the measurements. All numerical amounts are understood to be modified by the word “about” unless otherwise specifically indicated. Unless otherwise indicated, all measurements are understood to be made at approximately 25° C. and at ambient conditions, where “ambient conditions” means conditions under about 1 atmosphere of pressure and at about 50% relative humidity. All numeric ranges are inclusive and combinable to form narrower ranges not explicitly disclosed. For example, delineated upper and lower range limits are interchangeable to create further ranges.

The compositions can comprise, consist essentially of, or consist of, the essential components as well as optional ingredients described herein. As used herein, “consisting essentially of” means that the composition or component may only include additional ingredients that do not materially alter the basic and novel characteristics of the claimed composition or method. As used in the description and the appended claims, the singular forms “a”, “an”, and “the” are intended to include the plural forms as well, unless the context clearly indicates otherwise.

### Dropper

A dropper comprises: a bulb; a pipette coupled to the bulb; and a cap coupled to the bulb. The details of the bulb, pipette and cap are explained later.

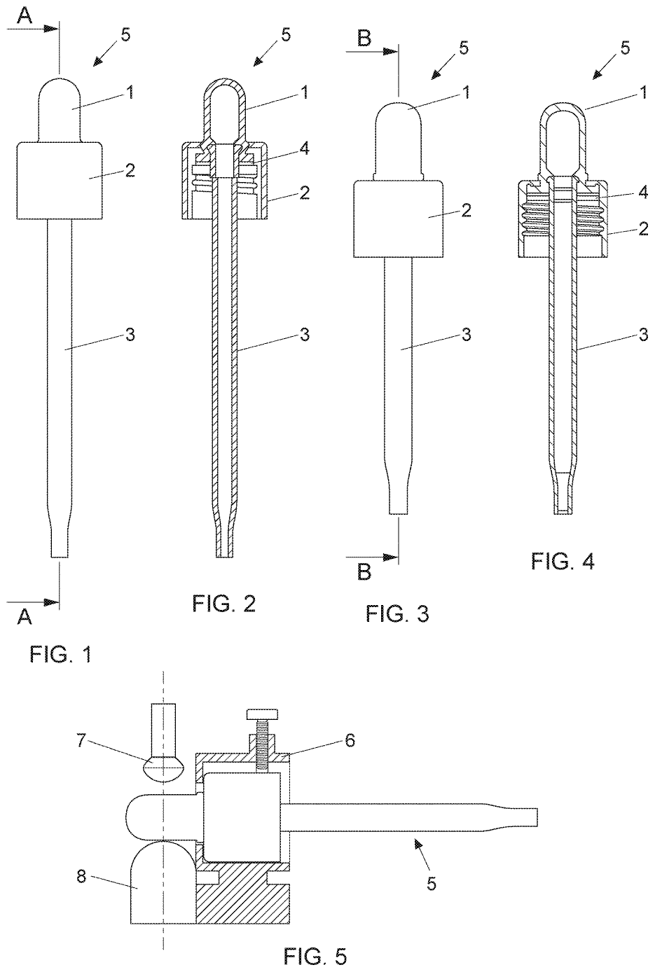

One example of the dropper shape and structure is shown in FIG. 1 and FIG. 2. FIG. 1 is a front view of a dropper 5 including a bulb 1, a cap 2 and a pipette 3, and FIG. 2 is A-A cross-sectional view of the dropper shown in FIG. 1, with a gasket 4.

Preferably, the dropper has a dispensing force of from about 4 N to about 20 N, more preferably from about 4 N to about 13 N, still more preferably from about 4 N to about 8 N in view of improved consumer experience of sucking and dispensing. The dispense force herein is that measured following ASTM D575-91 Test Method A—Compression Test at Specified Deflection with steel customized jigs and fixtures. FIG. 5 is an illustration of Compression Test for a dropper 5, with steel customized jigs 6 for holding the dropper and a finger fixture 7 and a base fixture 8. The measurement conditions are as follows:
Speed: 25.4 mm/min
Compression stroke: 4 mm

Preferably, the dropper is recyclable as a single unit. Preferably, the length of the dropper is greater than 5 cm in view of recyclability, and preferably up to about 125 mm.

### Bulb

The bulb useful herein comprises Thermoplastic Vulcanisates (TPV) having a shore A hardness of from about 40 to about 70, preferably from about 45 to about 65, more preferably from about 50 to about 65, still more preferably from about 55 to about 65, in view of a balance between dispensing force and anti-deformation. TPV useful herein is commercially available, for example, Milastomer (W600NS having Shore A hardness of 61) from Mitsui Chemicals.

The bulb composition comprising from about 50% to about 100% of TPV, preferably from about 80% to 100% more preferably from about 80% to about 95%, in view of recyclability, and also in view of a balance between dispensing force and anti-deformation. The remainder of the bulb composition may comprise, for example, colorant and another polymer which is different from TPV. Such another polymer can be, for example, polyethylene (PE) polypropylene (PP), and/or post-consumer recycled resin (PCR), preferably polyethylene (PE) and/or polypropylene (PP). Such colorant can be, for example organic or inorganic colorant (such as titanium dioxide). Such colorant and another polymer may form a colorant master batch, and the colorant master batch may be mixed with TPV.

The bulb usually has a wall made of the above bulb composition, and a chamber which is a space formed inside of bulb wall.

Preferably, the bulb has a wall thickness of from about 1 mm to about 2.5 mm, more preferably from about 1 mm to about 1.5 mm, still more preferably from about 1.1 mm to about 1.4 mm, even more preferably from about 1.1 mm to about 1.3 mm, in view of a balance between dispensing force and anti-deformation.

### Pipette

The pipette is coupled to the bulb. The pipette can be made of anything, for example, glass, polypropylene (PP), TPX (polymethylpentene). Preferably, the pipette is made of polypropylene, in view of recyclability. TPV is compatible with the PP recycling stream.

The pipette usually has an elongate body with a tubular shape to store the liquid to dispense and a lower end orifice to suck and dispense the liquid.

The lower end is preferably tapered to form a reduction in section which makes it possible to retain the liquid in the pipette especially when the pipette is out of the reservoir. The lower end of the pipette can be bent to improve the product intake and release. The pipette also has an upper end orifice to open to the chamber of the bulb.

### Cap

The cap is coupled to the bulb. The cap can be made of anything, for example, polypropylene (PP), metals such as Aluminum. Preferably, the cap is made of polypropylene, in view of recyclability. TPV is compatible with the PP recycling stream.

The gasket can be coupled to the cap. The gasket can be made of, for example, Polyethylene (PE), Foaming polyethylene, or NBR. Preferably, the gasket is made of Polyethylene or Foaming polyethylene, for recyclability.

### Bottle and Liquid

The cap holds the bulb and usually attaches to a bottle in a manner well known, for example, screw threads. The bottle usually contains a liquid inside to be sold as a product with the dropper. The liquid can be anything, for example, liquids having lower viscosities, and also viscous liquids such as gel, lotion, serum or essences, particularly useful in the field of beauty care products such as skin care and hair care. For example, the viscous product has a viscosity of between 5,000 and 35,000 centipoise, preferably between 10,000 and 20,000 centipoise (viscosity measured with the aid of a Brookfield LVT viscometer equipped with a spindle and rotating at a speed of three rotations per minute).

### Product Containing Dropper, Bottle and Liquid

The dropper can be used for a product, wherein the weight of the product (a sum of the weights of the dropper, bottle and liquid) is about 150 g or more, more preferably about 180 g or more, still more preferably about 200 g or more, even more preferably about 210 g or more, as anti-deformation properties are expected more in heavier products than lighter products.

### Two Piece Dropper

The dropper can be a two-piece dropper, comprising: a combined bulb and cap; and a pipette, the pipette coupled to the combined bulb and cap, wherein the bulb composed of: Thermoplastic Vulcanisates having a shore A hardness of from about 40 to about 70, preferably from about 45 to about 65, more preferably from about 50 to about 65.

The combined bulb and cap consist of a bulb portion and a cap portion, wherein bulb portion and the cap portion are fused together to become a single piece. Other than this combined bulb and cap, all the details are same as above described under the title “DROPPER”, “BULB”, “PIPETTE”, “CAP”, “BOTTLE and LIQUID” and “PRODUCT containing DROPPER, BOTTLE and LIQUID”.

One example of the two-piece dropper shape and structure is shown in FIG. 3 and FIG. 4. FIG. 3 is a front view of a two-piece dropper 5 including a combined bulb 1 and cap 2, and a pipette 3, and FIG. 4 is B-B cross-sectional view of the dropper shown in FIG. 3, with a gasket 4.

### EXAMPLES

### Dropper

| | Ex. 1 | Ex. 2 | Ex. 3 | CEx. i | CEx. ii |
|---|---|---|---|---|---|
| Dropper shape | Shown in | Shown in | Shown in | Shown in | Shown in |
| and structure | FIG. 1 and 2 | FIG. 1 and 2 | FIG. 3 and 4 | FIG. 1 and 2 | FIG. 1 and 2 |
| Pipette/Cap | PP pipette, | PP pipette, | PP pipette, | PP pipette, | PP pipette, |
| | PP cap with | PP cap with | PP cap with | PP cap with | PP cap with |
| | foaming PE | foaming PE | foaming PE | foaming PE | foaming PE |
| | gasket | gasket | gasket | gasket | gasket |
| Bulb | 95% TPV, | 95% TPV, | 95% TPV, | 95% TPS | 95% TPS |
| composition | having a | having a | having a | having a | having a |
| | Shore A | Shore A | Shore A | Shore A | Shore A |
| | hardness of | hardness of | hardness of | hardness of | hardness of |
| | 61*1 | 61*1 | 61*1 | 45 *2 | 50 *3 |
| | and 5% | and 5% | and 5% | and 5% | and 5% |
| | inorganic | inorganic | inorganic | inorganic | inorganic |
| | colorant | colorant | colorant | colorant | colorant |
| Wall thickness | 1.25 | 1.35 | 1.5 | 1.5 | 1.5 |
| of the bulb | | | | | |
| (mm) | | | | | |
| Dispensing | 6.8 | 7.6 | 10.0 | 9.4 | 9.6 |
| force (N) | | | | | |

Anti-deformation test:
Test Method: ISTA (International Safe Transit Association) 6A Single)
Result:
◯: No dropper shape deformation or wrinkle is observed
Δ: No dropper shape deformation is observed, but wrinkle is observed
X: Dropper shape deformation is observed

| | | | | | |
|---|---|---|---|---|---|
| With 190 g | ◯ | ◯ | ◯ | X | ◯ |
| product weight | | | | | |
| With 220 g | ◯ | Δ | Δ with | X | X |
| product weight | | | deeper and/or | | |
| | | | wider | | |
| | | | wrinkle than | | |
| | | | Ex. 2 | | |
| With 260 g | ◯ | Δ | Δ with | X | X |
| product weight | | | deeper and/or | | |
| | | | wider | | |
| | | | wrinkle than | | |
| | | | Ex. 2 | | |

*1TPV (Thermoplastic Vulcanisates) W600NS supplied from Mitsui
*2 TPS (thermoplastic styrene) KBG TF4ATL-LF5
*3 TPS (thermoplastic styrene) KBG TF5PAO

Ex. 1 through Ex. 3 are the examples. The dropper can comprise a bulb comprising recyclable material, and has a good balance between dispensing force and anti-deformation. Compared to commonly used bulbs using rubber, Examples 1-3 using TPV has improved recyclability. Balance between dispensing force and anti-deformation can be understood by the comparison to Comparative examples CEx.i and CEx. ii. Compared to the comparative examples using TPS, Examples 1-3 shows improved anti-deformation properties while not increasing dispensing force, especially when using with products having heavier weight and/or at a certain wall thickness.

### Combinations

1. A dropper, comprising: a bulb; a pipette coupled to the bulb; and a cap coupled to the bulb; wherein the bulb composed of: Thermoplastic Vulcanisates having a shore A hardness of from about 40 to about 70, preferably from about 45 to about 65, more preferably from about 50 to about 65, still more preferably form about 55 to about 65.
2. The dropper of the preceding feature, wherein the bulb comprising from about 50% to about 100% of Thermoplastic Vulcanisates, preferably from about 80% to 100% more preferably from about 80% to about 95%.
3. The dropper of any of the preceding features, wherein the dropper has a dispensing force of from about 4 N to about 20 N, preferably from about 4 N to about 13 N, more preferably from about 4 N to about 8 N.
4. The dropper of any of the preceding features, wherein the bulb has a wall thickness of from about 1 mm to about 2.5 mm, preferably from about 1 mm to about 1.5 mm, more preferably from about 1.1 mm to about 1.4 mm, still more preferably from about 1.1 mm to about 1.3 mm.
5. The dropper of any of the preceding features, wherein the dropper is for a product comprising the dropper, a bottle, and a liquid inside of the bottle, wherein the weight of the product (a sum of the weights of the dropper, bottle and liquid) is about 150 g or more, preferably about 180 g or more, more preferably about 200 g or more, still more preferably about 210 g or more.
6. The dropper of any of the preceding features, wherein the cap is made of polypropylene.
7. The dropper of any of the preceding features, wherein the pipette is made of polypropylene.
8. The dropper of any of the preceding features, wherein the dropper is recyclable as a single unit.
9. The dropper of any of the preceding features, wherein a length of the dropper is greater than 5 cm.
10. A two-piece dropper, comprising: a combined bulb and cap; and a pipette, the pipette coupled to the combined bulb and cap, wherein the bulb composed of: Thermoplastic Vulcanisates having a shore A hardness of from about 40 to about 70, preferably from about 45 to about 65, more preferably from about 50 to about 65.
11. The two-piece dropper of the preceding feature, wherein the combined bulb and cap consists of a bulb portion and a cap portion, wherein bulb portion and the cap portion are fused together to become a single piece.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A dropper, comprising: a bulb; a pipette coupled to the bulb; and a cap coupled to the bulb; wherein the bulb comprises a thermoplastic vulcanisates having a shore A hardness of from about 40 to about 70.

2. The dropper of claim 1, wherein Thermoplastic Vulcanisates has a shore A hardness of from about 50 to about 65.

3. The dropper of claim 2, wherein Thermoplastic Vulcanisates has a shore A hardness of from about 55 to about 65.

4. The dropper of claim 1, wherein the bulb comprises from about 50% to about 100% of Thermoplastic Vulcanisates.

5. The dropper of claim 4, wherein the bulb comprises from about 80% to 100% of Thermoplastic Vulcanisates.

6. The dropper of claim 5, wherein the bulb comprises from about 80% to about 95% of Thermoplastic Vulcanisates.

7. The dropper of claim 1, wherein the dropper has a dispensing force of from about 4 N to about 20 N.

8. The dropper of claim 7, wherein the dropper has a dispensing force of from about 4 N to about 8 N.

9. The dropper of claim 1, wherein the bulb has a wall thickness of from about 1 mm to about 2.5 mm.

10. The dropper of claim 1, wherein the dropper is for a product comprising the dropper, a bottle, and a liquid inside of the bottle, wherein the weight of the product (a sum of the weights of the dropper, bottle and liquid) is about 150 g or more.

11. The dropper of claim 1, wherein the cap is made of polypropylene.

12. The dropper of claim 1, wherein the pipette is made of polypropylene.

13. The dropper of claim 1, wherein the dropper is recyclable as a single unit.

14. The dropper of claim 1, wherein a length of the dropper is greater than 5 cm.

15. A two-piece dropper, comprising: a combined bulb and cap; and a pipette, the pipette coupled to the combined bulb and cap, wherein a bulb portion of the combined bulb and cap comprises thermoplastic vulcanisates having a shore A hardness of from about 40 to about 70.

16. The two-piece dropper of claim 15, wherein Thermoplastic Vulcanisates has a shore A hardness of from about 45 to about 65.

17. The two-piece dropper of claim 16, wherein Thermoplastic Vulcanisates has a shore A hardness of from about 55 to about 65.

18. The two-piece dropper of claim 15, wherein the dropper has a dispensing force of from about 4 N to about 8 N.

19. The two-piece dropper of claim 15, wherein the bulb portion has a wall thickness of from about 1.1 mm to about 1.3 mm.

20. The two-piece dropper of claim 15, wherein the combined bulb and cap consists of the bulb portion and a cap portion, wherein bulb portion and the cap portion are fused together to become a single piece.
